(19) United States
(12) Patent Application Publication
(10) Pub. No.: US 2015/0323024 A1
(43) Pub. Date: Nov. 12, 2015

(54) DISC BRAKE CALLIPER

(71) Applicant: FRENI BREMBO S.p.A., Curno, Bergamo (IT)

(72) Inventors: Cristian CRIPPA, Curno, Bergamo (IT); Armando PUDDU, Curno, Bergamo (IT)

(21) Appl. No.: 14/410,995

(22) PCT Filed: Jun. 24, 2013
(86) PCT No.: PCT/IB2013/055174

§ 371 Date: Dec. 23, 2014

(30) Foreign Application Priority Data
Jul. 4, 2012 (IT) PD2012A000214

(51) Int. Cl. F16D 65/097; F16D 55/226; F16D 65/00

(52) U.S. Cl. CPC F16D 65/0971; F16D 65/0068; F16D 55/226; F16D 2055/0016

(57) ABSTRACT

A disc brake calliper includes a calliper body housing at least one pad (12) having a support plate (16) and a friction portion (20), and at least one thruster (24) for the pad (12). The callipe includes an attachment device (48) for joining to each other at least one thruster (24) to at least one pad (12), the attachment device (48) being placed between the thrust wall (32) and the support plate (16). The attachment device (48) is in one piece and includes a first connection portion (52) which connects the attachment device (48) to the thruster (24) and a second connection portion (56) which connects the attachment device (48) to the pad (12). The first connection portion (52) is at least partially housed inside the seat (44) of the thruster (24) and the second connection portion (56) includes a plate (60) glued to the support plate (16) of the pad (12).

### FIELD OF APPLICATION

The present invention relates to a disc brake calliper provided with a retention device of the pads suitable for joining the pads and the respective actuation devices of the pads to each other.

### STATE OF THE ART

In particular in the disk brake sector, it is known of to provide return devices of the pads which, in the absence of the braking force, i.e. when the calliper is not working, have the function of moving the pads away from the braking band.

It is important to move the pads away from the disk brake when no braking force needs to be exercised, both to prevent possible residual braking torques and to prevent the noise caused by continuous rubbing between the friction material of the pad and the disk brake. In addition, a continuous contact with the disk brake may also cause anomalous wear, or in any case premature wear of said pad.

### PRESENTATION OF THE INVENTION

To resolve the aforementioned problems, up to today solutions have been adopted in the prior art using springs of various sizes and shapes which act on the pads, in particular on the relative support pads of the friction material, and which axially push the pads away from the disk brake, so as to press the pads against the relative thrust pistons.

Obviously such pads exert a thrust force decidedly inferior to that exercised by the thrust pistons housed in the calliper body so as not to influence the braking action. When the piston does not exert a thrust the pad is thus moved away from the disk brake by the elastic action of the spring.

Such solutions of the prior art have several drawbacks.

In fact, the springs, on account of the dimensions and limited spaces, are not always able to exert an elastic thrust on the pad sufficient to overcome the internal friction and thus ensure a correct return in the release phase of the braking action.

In fact, the pads are often mounted so as to slide on guide pins and/or on the support surfaces defining the housing seats of said pads made in the calliper body. The friction forces at play may be high and generate sticking phenomena of the pad itself. In addition, the functioning conditions and thereby thermal dilations of the calliper body and/or pads themselves may modify the frictions and worsen the sticking. Such sticking may block the return movements of the pad which remains in contact rubbing on the braking surface of the disk brake; in some cases the pad moves back only partially, in correspondence with the thrust portions of the springs and may thus cause asymmetric wear of the friction material of the pad.

To overcome such limitations coupling devices of the pads to the relative thrust pistons are provided. The return function of the pads thereby being directly entrusted to the thrust pistons which are fitted in turn with elastic return means. The solutions of the prior art however provide for complex and expensive attachment devices to be made.

In addition, the solutions of the prior art have several drawbacks: for example they require the production of special pads which comprise specific protuberances for the mechanical attachment thereof to the devices. In addition, the devices of the prior art comprise a plurality of components joined to each other: such components inevitably present relative clearances which reduce the return efficacy of the pads in that for example they do not guarantee that the device and relative piston are coaxial. An absence of coaxiality may again cause highly undesirable sticking or asymmetric reversing of the pads.

In addition, such clearance induces vibrations and noise which are often unacceptable for the user.

The need is therefore felt to overcome the drawbacks and limitations mentioned in relation to the prior art

Such requirement is satisfied by a disk brake calliper according to claim 1.

In particular such requirement is satisfied by a disk brake calliper comprising a calliper body which houses at least partially a pad suitable for exerting a braking action on an associable disc brake, the pad comprising a support plate and a friction portion, supported by the support plate and suitable for being pressed against the associable disc brake, the calliper body housing at least one thrust means for said pad, wherein the thrust means comprise a body which extends from a thrust wall, suitable for exerting a thrust force on the support plate of the pad and an actuation wall, opposite said thrust wall, the thrust means exerting a thrust action in an axial direction X-X perpendicular to said pad, wherein the body delimits a seat open towards the thrust wall and directly facing the associable pad. Advantageously, the calliper comprises an attachment device suitable for joining the at least one thrust means to the at least one pad, the attachment device being placed between the thrust wall and the support plate of the pad, wherein the attachment device is in one piece and comprises a first connection portion which connects the attachment device to the thrust means and a second connection portion which connects the attachment device to the pad, wherein the first connection portion is at least partially housed inside said seat of the thrust means and wherein the second connection portion comprises a plate glued to the support plate of the pad.

According to a possible embodiment, the thrust means comprises a body made in one piece and delimiting said seat which houses the first connection portion of the attachment device.

According to a further embodiment, the thrust means comprises a body and an insert, the insert being joined to the body and delimiting said seat which houses the first connection portion of the attachment device.

According to a possible embodiment, the first connection portion comprises at least two flexible tabs inserted inside the seat in such a way as to abut with an inner lateral wall of said seat. The presence of at least two elastic tabs improves the stability and attachment of the attachment device.

According to a possible embodiment, said flexible tabs, in an assembled configuration inside the seat, are positioned substantially perpendicular to the second connection portion. Such perpendicularity further improves the attachment of the attachment device.

According to a possible embodiment, the flexible tabs, in a dismantled configuration, are divergent in a perpendicular direction from the second connection portion so as to enter into the seat with interference. An even more secure attachment of the attachment device to its seat is thereby ensured.

According to a possible embodiment, said flexible tabs have tapered ends so as to dig into the inner side wall of the seat. Such configuration prevents possible detachment of the attachment device from the thrust means.

According to a possible embodiment, the flexible tabs have an axial extension less than the axial depth of the seat so as not to come into contact with an end wall of the seat opposite the thrust wall. This way interference with the seat is prevented and it is ensured that the first connection portion enters the respective seat completely, permitting the second connection portion to move into abutment with the thrust wall.

According to a possible embodiment, the flexible tabs are positioned in an axial symmetrical manner to an axis of symmetry of the first connection portion parallel to the axial direction X-X.

According to a possible embodiment, the flexible tabs are made in one piece by shearing and bending a central portion of the attachment device. This way production of the attachment device is simplified, reducing production and assembly costs and times; in addition clearance inside the attachment device itself is avoided, the presence of several components connected to each other not being provided for.

According to a possible embodiment, the plate of the second connection portion is a circular crown shape positioned symmetrically in relation to the first connection portion. Such plate ensures a secure attachment to the pad.

According to a possible embodiment, said plate extends for an area greater than the thrust wall and less than the support plate of the pad.

According to a possible embodiment said plate is directly pinched, in the axial direction X-X, between the support plate of the pad and the thrust wall of the thrust means.

According to a possible embodiment, the support plate of the pad comprises an aperture or hollow positioned at the seat of the thrust means.

### DESCRIPTION OF THE DRAWINGS

Further characteristics and advantages of the present invention will be more clearly comprehensible from the description given below of its preferred and non-limiting embodiments, wherein:

FIGS. 1-2 show views partially in cross-section of disk brake callipers according to the present invention;

FIG. 3 is a cross-section view, in an assembled configuration, of several components of the callipers in FIGS. 1-2;

FIG. 4 is a cross-section view, in separate parts, of the components in FIG. 3;

FIG. 5 shows a perspective view of several components of the calliper according to the present invention;

FIGS. 6-7 show views from different angles of an attachment device of the calliper according to the present invention.

The elements or parts of elements common to the embodiments described below will be indicated using the same reference numerals.

### DETAILED DESCRIPTION

With reference to the aforementioned figures, reference numeral 4 globally denotes a disk brake calliper comprising a calliper body 8 which houses at least partially a pad 12 suitable for exerting a braking action on an associable disc brake (not shown).

For the purposes of the present invention, any type of brake calliper is intended, i.e. both fixed and floating callipers, as well as single block callipers and/or callipers divided into two half-callipers.

The pad comprises a support plate 16 and a friction portion 20, supported by the support plate 16 and suitable for being pressed against the associable disc brake. For the purposes of this application, the support plate and the friction portion may be of any size or shape, as well as made from any suitable material.

The calliper body 8 houses at least one thrust means of said pad 12, wherein the thrust means 24 may be of the single block type, comprising a body 28 in one piece, or the thrust means may be made of two pieces comprising a body 28 and an insert 30.

For example, the single block type thrust means 24 is made from aluminium or an alloy comprising aluminium; the thrust means 24 in two pieces may for example have a body 28 made for example from metal and the insert 30 made from phenolic material; obviously for the purposes of the present invention any material or combination of materials suitable for the purpose may be used.

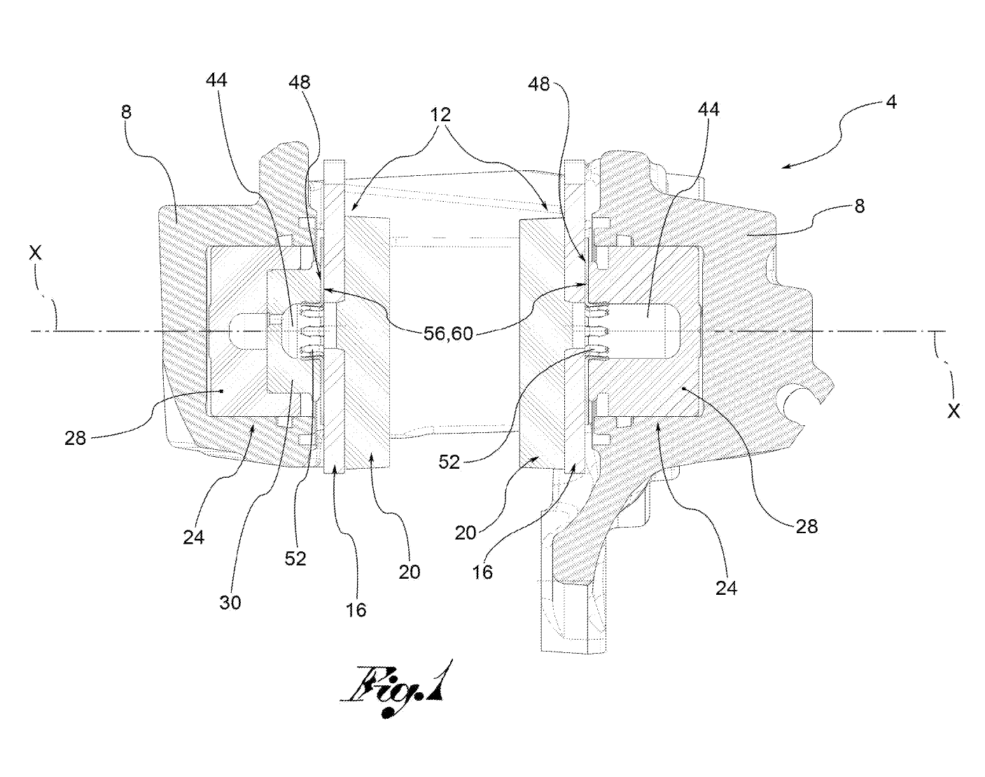

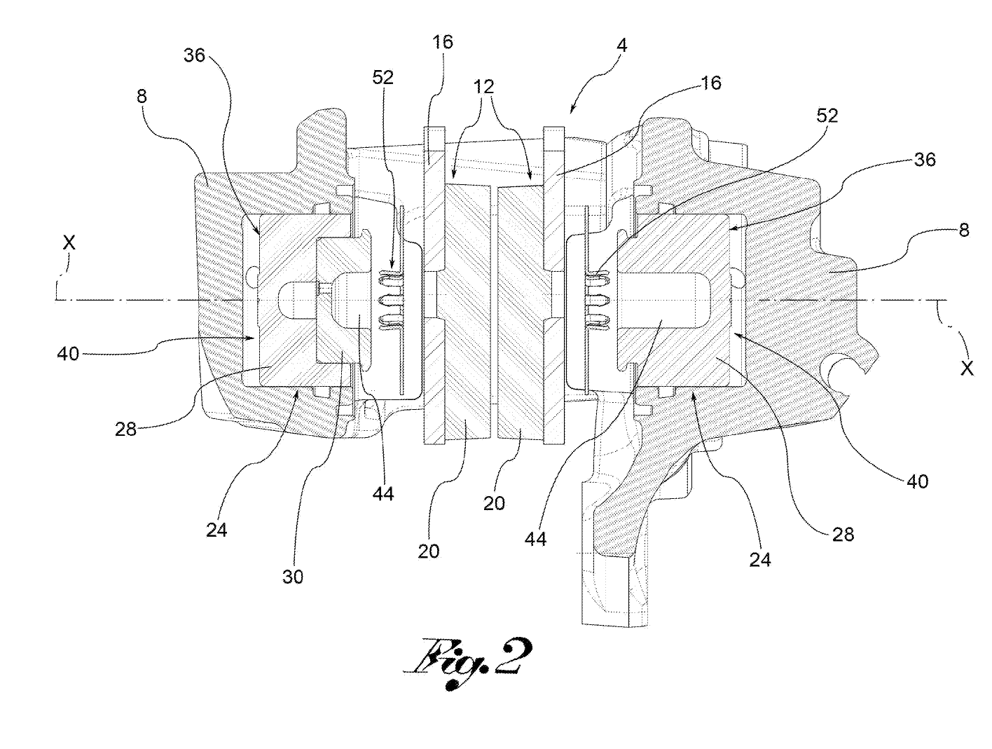

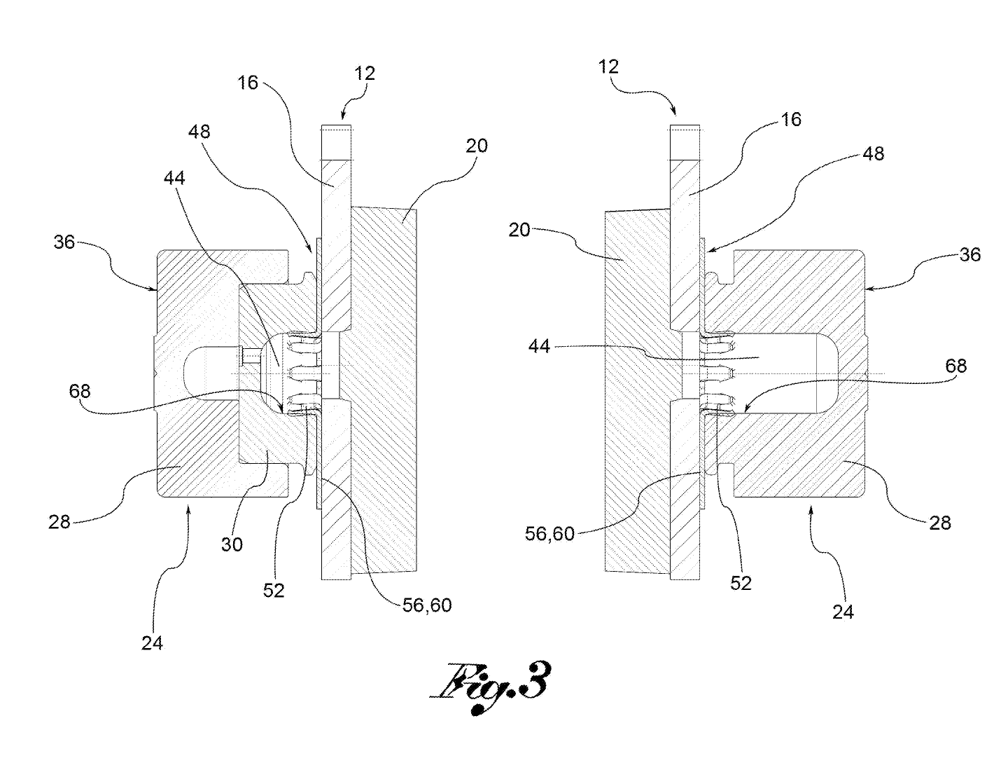

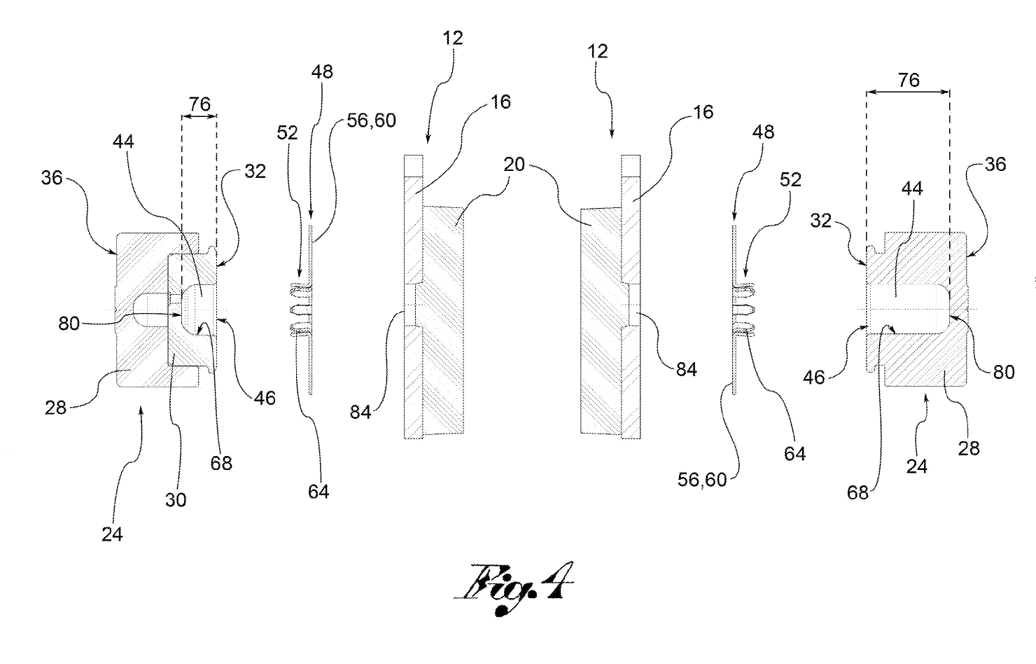

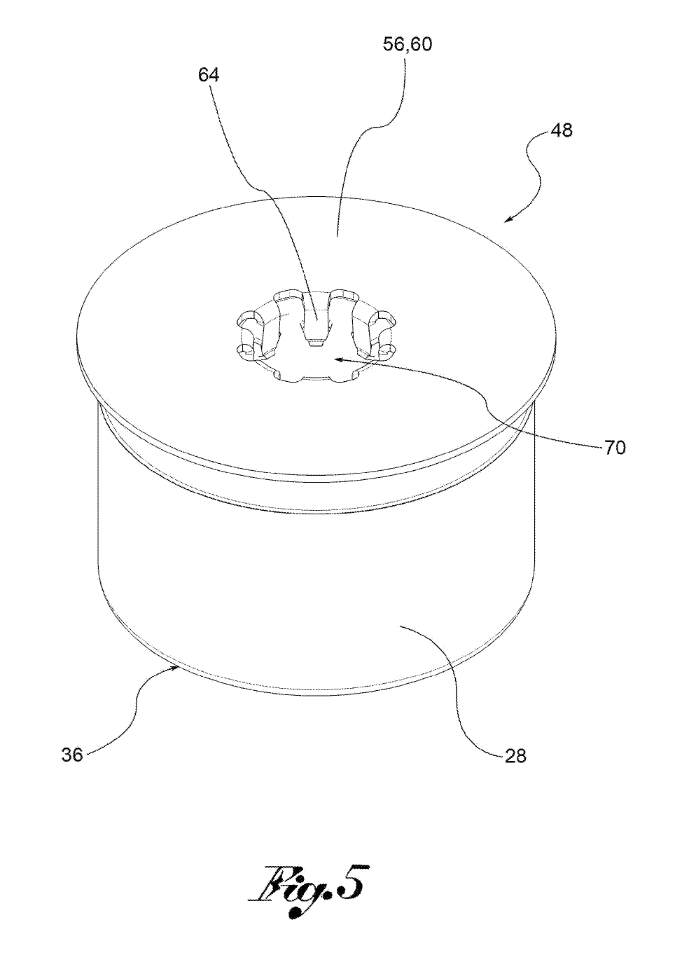

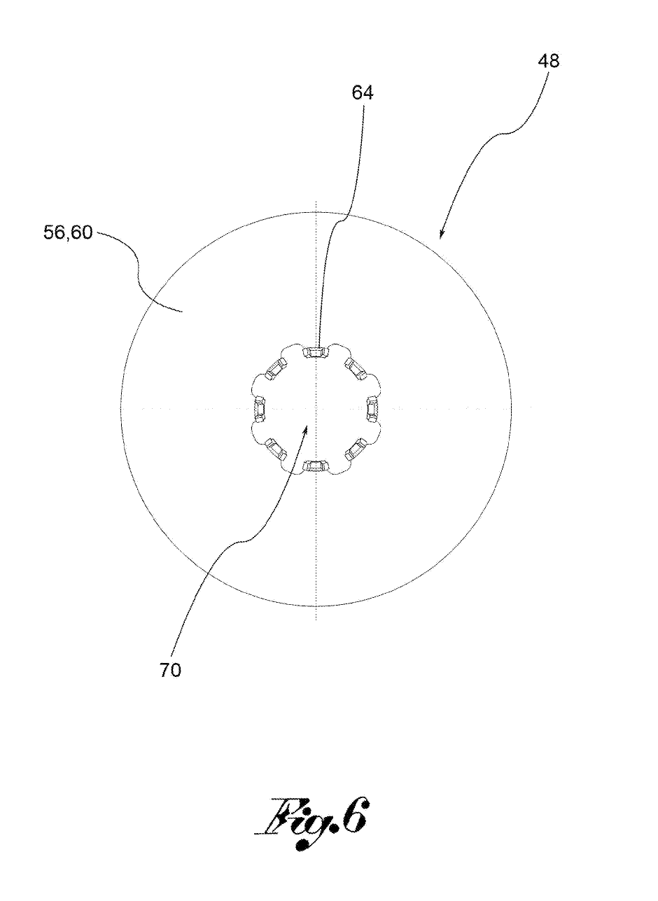

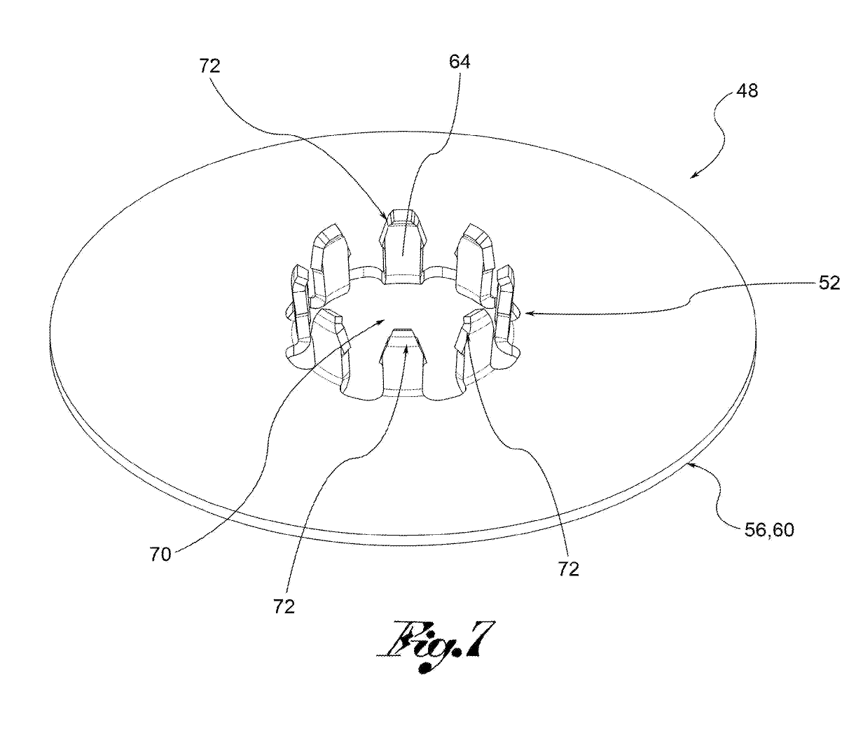

For example FIGS. 1-2 show disk brake callipers simultaneously comprising both thrust means 24 provided with a body 28 in a single piece and thrust means 24 comprising a body 28 and a relative insert 30.

The thrust means 24 extend from a thrust wall 32, suitable for exerting a thrust force on the support plate 16 of the pad 12, to an actuation wall 36, opposite said thrust wall 32. The thrust means exert a thrust action in an axial direction X-X perpendicular to said pad 12.

The axial direction X-X is substantially perpendicular to the rotation axis of the associable disk brake.

The actuation wall 36 receives the thrust from actuation means, preferably of the hydraulic type. For example, the calliper body 8 defines housing seats 40 which house and guide the thrust means 24. For example, the housing seats 40 are counter shaped to the thrust means 24 so as to guide them in their axial thrust movement against the pads 12. The housing seats 40 are preferably filled with liquid which, pressurised by means of a pump, exerts a thrust on the actuation wall 36.

For the purposes of the present invention, mechanical actuations of the thrust means may also be provided for: such as by means of screw, lever and similar mechanisms as well as by electro-mechanical or electromagnetic type actuators.

The thrust means, at the body 28 or at the insert 30 delimit a seat 44 open towards the thrust wall 32 and directly facing the associable pad 12, in particular the support plate 16. In other words, the thrust wall 32 has an aperture 46 directly facing the support plate 16.

Preferably, the thrust means 24 are cylindrical pistons fitted with said seat 44 also cylindrical: this way the thrust wall 32 has a circular crown configuration. Advantageously, the calliper 4 comprises an attachment device 48 suitable for joining at least one thrust means 24, whether of the single block type comprising a body 28 in one piece or of the type in two pieces comprising a body 28 and an insert 30, to at least one pad 12, wherein the attachment device 48 is placed between the thrust wall 32 and the support plate 16 of the pad 12.

Advantageously, the attachment device 48 is in one piece and comprises a first connection portion 52 which connects the attachment device 48 to the thrust means 24, whether of the single block type comprising a body 28 in one piece or of the type in two pieces comprising a body 28 and an insert 30, and a second connection portion 56 which connects the attachment device 48 to the pad 12. The first connection portion 52 is at least partially housed inside said seat 44 of the thrust means 24 and the second connection portion 56 comprises a plate 60 glued to the support plate 16 of the pad 12.

Preferably, the attachment device 48 is made of metal, such as for example steel or stainless steel sandwiching a damping plastic material.

Preferably, the plate 60 is glued by means of a glue such as an acrylic, silicone or polyurethane glue. The gluing joins the attachment device 48 and the support plate 16 to each other and thus to the pad 12, especially during the reversing step of the thrust means 24 which is able to drag the pad 12 with it, moving it away from the associable disk brake.

According to one embodiment, the first connection portion 52 comprises at least two flexible tabs 64 inserted inside the seat 44 in such a way as to abut with an inner lateral wall 68 of said seat 44.

Preferably, the flexible tabs 64, in an assembled configuration inside the seat 44, are positioned substantially perpendicular to the second connection portion 56.

Preferably, the flexible tabs 64 are made by shearing and bending a central portion of the plate 60. This way the tabs are made in one piece with the plate 60; preferably the plate 60 has a central hole 70. Preferably, said central hole 70 is aligned with the aperture of the seat 44 on the thrust wall 32. Following shearing, at the central hole 70, the plate 60 has an alternation of peaks 71, corresponding to the attachment sections of the flexible tabs 64 and valleys 73 which connect the attachment cross-section to said plate.

The flexible tabs 64, in a dismantled configuration, are divergent in a perpendicular direction from the second connection portion 56 so as to enter into the seat with interference. In other words, thanks to the divergent conformation, the flexible tabs 64 entering inside the seat grate against the inner side wall 68 of said seat so as to close inwards annulling the divergence and moving in a direction substantially perpendicular to the second connection portion, i.e. in an axial direction X-X.

According to one embodiment, the flexible tabs 64 have tapered ends 72 so as to dig into the inner side wall 68 of the seat 44.

Preferably, the flexible tabs have an axial extension less than the axial depth 76 of the seat 44 so as not to come into contact with an end wall 80 of the seat 44 opposite the thrust wall 32, even when the second connection portion 56 moves into abutment with the thrust wall 32.

Preferably, the flexible tabs 64 are positioned in an axial symmetrical manner to an axis of symmetry of the first connection portion 52 parallel to the axial direction X-X.

The flexible tabs 64 are made in one piece by shearing and bending a central portion of the attachment device 48.

According to one embodiment, the plate 60 of the second connection portion 56 is a circular crown shape positioned symmetrically in relation to the first connection portion 52.

For example, said plate 60 extends for an area greater than the thrust wall 32 and less than the support plate 16 of the pad 12.

Preferably, said plate 60 is directly pinched, in the axial direction X-X, between the support plate 16 of the pad 12 and the thrust wall 32 of the thrust means 24.

The support plate 16 of the pad 12 may comprise an aperture or hollow 84 positioned at the seat 44 of the thrust means 24.

As may be seen from the description, the disk brake calliper according to the present invention makes it possible to overcome the drawbacks presented in relation to the prior art.

In particular the disk brake calliper is cheap to produce.

In addition, the attachment device of the pads is cheap to produce and assemble.

Such device is safe and reliable to assemble and avoids risks of the pad sticking in its reverse movement.

Such attachment device is able to flexibly adapt to any mechanical and/or thermal deformations of the pad and of the calliper body during its functioning.

The device is in one piece and thereby does not entail internal clearances which could generate noise, vibrations and even sticking.

Advantageously, the attachment device which the present invention relates to may be applied to any kind of pad without the need for any modification for example to the support plate of said pad. In other words, the support plate of the pad does not need to be fitted with appendages to permit its axial blocking between the attachment device and the pad; consequently such attachment device may also be applied, at a later date, to pre-existing pads.

A person skilled in the art may make numerous modifications and variations to the disk brake callipers described above so as to satisfy contingent and specific requirements while remaining within the sphere of protection of the invention as defined by the following claims.

1. Disc brake calliper comprising
a calliper body which houses at least partially a pad suitable for exerting a braking action on an associable disc brake, the pad comprising:
a support plate and a friction portion, supported by the support plate and suitable for being pressed against the associable disc brake,
the calliper body housing at least one thrust means of said pad, wherein the thrust means comprises a body and extends from a thrust wall, suitable for exerting a thrust force on the support plate of the pad and an actuation wall, opposite said thrust wall, the thrust means exerting a thrust action in an axial direction perpendicular to said pad,
wherein the thrust means delimit a seat open towards the thrust wall and directly facing the associable pad,
wherein the calliper comprises an attachment device suitable for joining to each other at least one thrust means with at least one pad, the attachment device being placed between the thrust wall and the support plate of the pad,
wherein the attachment device is in one piece and comprises a first connection portion which connects the attachment device to the thrust means and a second connection portion which connects the attachment device to the pad, wherein the first connection portion is at least partially housed inside said seat of the thrust means and wherein the second connection portion comprises a plate glued to the support plate of the pad.

2. Disc brake calliper according to claim 1, wherein the thrust means comprise a body made in one piece and delimiting said seat which houses the first connection portion of the attachment device.

3. Disc brake calliper according to claim 1, wherein the thrust means comprise a body and an insert, the insert being joined to the body and delimiting said seat which houses the first connection portion of the attachment device.

4. Disc brake calliper according to claim 1, wherein the first connection portion comprises at least two flexible tabs inserted inside the seat to abut with an inner lateral wall of said seat.

5. Disc brake calliper according to claim 4, wherein said flexible tabs, in an assembled configuration inside the seat, are positioned substantially perpendicular to the second connection portion.

6. Disc brake calliper according to claim 4, wherein said flexible tabs, in a dismantled configuration are divergent in a perpendicular direction from the second connection portion so as to enter into the seat with interference.

7. Disc brake calliper according to claim 4, wherein said flexible tabs have tapered ends so as to dig into the inner side wall of the seat.

8. Disc brake calliper according to claim 4, wherein said flexible tabs have an axial extension less than an axial depth of the seat so as not to come into contact with an end wall of the seat opposite the thrust wall.

9. Disc brake calliper according to claim 4, wherein said flexible tabs are positioned in an axial symmetrical manner to an axis of symmetry of the first connection portion parallel to the axial direction.

10. Disc brake calliper according to claim 4, wherein said flexible tabs are made in one piece by shearing and bending a central portion of the attachment device.

11. Disc brake calliper according to claim 1, wherein the plate of the second connection portion is a circular crown shape positioned symmetrically in relation to the first connection portion.

12. Disc brake calliper according to claim 11, wherein said plate extends for an area greater than the thrust wall and less than the support plate of the pad.

13. Disc brake calliper according to claim 1, wherein the plate has a central hole said central hole being aligned with an aperture of the seat on the thrust wall.

14. Disc brake calliper according to claim 11, wherein said plate is directly pinched, in the axial direction, between the support plate of the pad and the thrust wall of the thrust means.

15. Disc brake calliper according to claim 1, wherein the support plate of the pad comprises an aperture or hollow positioned at the seat of the thrust means.
